(19) United States
(12) Patent Application Publication
(10) Pub. No.: US 2011/0157001 A1
(43) Pub. Date: Jun. 30, 2011

(54) METHOD AND APPARATUS FOR DISPLAY FRAMEBUFFER PROCESSING

(75) Inventors: Raja Bose, Mountain View, CA (US); Jorg Brakensiek, Mountain View, CA (US)

(73) Assignee: NOKIA CORPORATION, Espoo (FI)

(21) Appl. No.: 12/826,650

(22) Filed: Jun. 29, 2010

Related U.S. Application Data
(60) Provisional application No. 61/224,348, filed on Jul. 9, 2009.

(51) Int. Cl. G09G 5/00; G09G 5/36

(52) U.S. Cl. 345/156; 345/545

(57) ABSTRACT

Various methods for display framebuffer processing are provided. One example method include determining, via a processor, that update criteria associated with a display region has been satisfied, and comparing current frame data for the display region to subsequent frame data for the display region to determine frame data changes associated with the display region. In this regard, the comparing is performed in response to the update criteria being satisfied. The example method may also include facilitating presentation of the frame data changes within the display region on a display. Similar and related example methods and example apparatuses are also provided.

### RELATED APPLICATIONS

This application was originally filed as U.S. Provisional Application No. 61/224,348 on Jul. 9, 2009, which is incorporated herein by reference in its entirety.

### TECHNICAL FIELD

Embodiments of the present invention relate generally to generating an image on a display, and, more particularly, relate to a method and apparatus for display framebuffer processing.

### BACKGROUND

Mobile computing devices continue to evolve, such that the computing devices are capable of supporting new and powerful applications. For example, many cellular telephones are now capable of determining a current location of the phone via a Global Positioning System (GPS) or other means. The ability to perform locating provides a basis for numerous applications of the location data.

As mobile communications device increase in functionality, users demand to interface with their mobile computing device in a variety of ways. For example, considering again the GPS capabilities, a user may wish to have a mobile computing device interface with a device having a larger display in a vehicle, for displaying maps and other location information. Similarly, a mobile computing device operating as a media player may also interface with another device having a display, again possibly a display in a vehicle, to provide the user with an interface to the mobile computing device via a display located in the traditional location for a radio.

To interface and support a remote display, the mobile computing device may provide frame data to the remote display for presentation on the remote display. The data processing associated with supporting the image on the remote display may require repetitive and intensive processing of the frame data consuming substantial portions of the processing power available to the mobile communications device.

### BRIEF SUMMARY

Example methods and example apparatuses are described that provide for display framebuffer processing to realize a reduction in the processing required to support a dynamic image on a display, such as a remote display configured to mimic the image displayed on a computing device display. In this regard, according to various example embodiments, a display area may be divided into separate regions. Each region may have associated update criteria. When the update criteria is satisfied, a scan of the frame data in a framebuffer may be performed to identify changes to the frame data associated with the display region. If changes are identified, the changes may be provided to the display to update the display region. The update criteria may be satisfied when, for example, a timer threshold is passed, user input is provided, an application context changes, or changes to the display content of a related display region are identified. These and other triggering or update criteria may be utilized for initiating an analysis of a the frame data associated with a display region.

Various example embodiments of the present invention are described herein. One example embodiment is a method for display framebuffer processing. The example method includes determining, via a processor, that update criteria associated with a display region has been satisfied, and comparing current frame data for the display region to subsequent frame data for the display region to determine frame data changes associated with the display region. In this regard, the comparing is performed in response to the update criteria being satisfied. The example method may also include facilitating presentation of the frame data changes within the display region on a display.

An additional example embodiment is an apparatus configured for display framebuffer processing. The example apparatus comprises at least one processor and at least one memory including computer program code. The at least one memory and the computer program code may be configured to, with the at least one processor, cause the example apparatus to perform various functionality. In this regard, the example apparatus is caused to perform determining that update criteria associated with a display region has been satisfied, and comparing current frame data for the display region to subsequent frame data for the display region to determine frame data changes associated with the display region. In this regard, the comparing is performed in response to the update criteria being satisfied. The example apparatus may also be caused to perform facilitating presentation of the frame data changes within the display region on a display.

Another example embodiment is an example computer program product for display framebuffer processing. The example computer program product comprises at least one computer-readable storage medium having executable computer-readable program code instructions stored therein. The computer-readable program code instructions of the example computer program product are for causing an apparatus to perform determining that update criteria associated with a display region has been satisfied, and comparing current frame data for the display region to subsequent frame data for the display region to determine frame data changes associated with the display region. In this regard, the comparing is performed in response to the update criteria being satisfied. The computer-readable program code instructions also cause the apparatus to perform facilitating presentation of the frame data changes within the display region on a display.

Another example embodiment is an apparatus for display framebuffer processing. The example apparatus includes means for determining that update criteria associated with a display region has been satisfied, and comparing current frame data for the display region to subsequent frame data for the display region to determine frame data changes associated with the display region. In this regard, the comparing is performed in response to the update criteria being satisfied. The example apparatus may also include means for facilitating presentation of the frame data changes within the display region on a display.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a system for display framebuffer processing according to an example embodiment of the present invention;

FIG. 2 illustrates an example user interface separated into display regions according to an example embodiment of the present invention;

FIG. 3 illustrates a dependency graph for display framebuffer processing according to an example embodiment of the present invention;

FIG. 4 illustrates a block diagram of an apparatus for display framebuffer processing according to an example embodiment of the present invention;

FIG. 5 illustrates a block diagram of a mobile terminal for display framebuffer processing according to an example embodiment of the present invention; and

FIG. 6 illustrates flow charts of methods for display framebuffer processing according to various example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

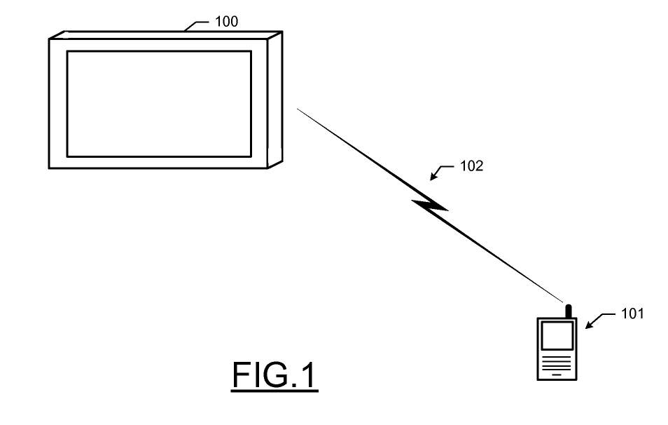

FIG. 1 illustrates an example system in accordance with various example embodiments of the present invention. The example system includes a remote display 100, User Equipment (UE) 101, and a communications link 102.

The remote display 100 may be any type of computing device configured to display an image. According to some example embodiments, the remote display 100 may include user interface components and functionality. In this regard, keypad 103 may be an optional user input device. In some example embodiments, the remote display 100 may include a touch screen display that is configured to receive input from a user via touch events with the display. Further, the remote display 100 may include a keyboard, speakers, a microphone, and the like. The remote display 100 may also include a communications interface for communicating with the UE 101 via the communications link 102.

The communications link 102 may be any type communications link capable of supporting communications between the remote display 100 and the UE 101. According to some example embodiments, the communications link 102 is a Bluetooth link. While the communications link 102 is depicted as a wireless link, it is contemplated that the communications link 102 may be a wired link.

The UE 101 may be any type of mobile computing and communications device. According to some example embodiments, the UE 101 is a mobile terminal. The UE 101 may be configured to communicate with the remote display 100 via the communications link 102. The UE 101 may also be configured to execute and implement applications via a processor and memory included within the UE 101.

According to some example embodiments, the UE 101 may be configured to, via the communications connection 102, direct the remote display 100 to present an image and receive user input provided via the remote display 100. The image presented by the remote display 100 may be the same image that is being presented on a display of the UE 101 or that would have been presented had the display of the UE 101 been active. For example, consider an example scenario where the remote display 100 is installed in a vehicle as a vehicle head unit. The driver of the vehicle may wish to use the remote display 100 as an interface to the UE 101 due, for example, to the convenient location of the remote display 100 within the vehicle. The UE 101 may be configured to link with the remote display 100, and direct the remote display 100 to present images or content. The UE 101 may do so by scanning a display framebuffer of the UE 101 and providing frame data to the remote display 100 via the communications link 102.

The interaction between the UE 101 and the remote display 100 provides an example of mobile device interoperability, which may also be referred to as smart space, remote environment, and remote client. In this regard, features and capabilities of the UE 101 may be projected onto an external environment (e.g., the remote display 100), and the external environment may appear as if the features and capabilities are inherent to external environment such that the dependency on the UE 101 is not apparent to a user. Projecting the UE 101's features and capabilities may involve exporting the User Interface (UI) screen of the UE 101, as well as command and control to the external environment whereby, the user may comfortably interact with the external environment in lieu of the UE 101.

When the user interface of the UE 101 is exported to, for example, the remote display 100, the UE 101 may periodically scan a display framebuffer to determine which portions of the UE 101's display have changed and communicate the changes to the remote display 100. Due to the relatively low processing capabilities of many mobile communications devices (e.g., UE 101), and increasing display resolutions of displays (e.g., Quarter-High Definition (QHD) resolutions, Wide Video Graphics Array (WVGA) resolutions, etc.), the processing overhead associated with framebuffer analysis may be substantial, such that the execution of other applications on the UE 101 may be affected (e.g., slowed). In turn, the User Experience (UX) of accessing the UE 101's functionalities through the remote display 100 may be diminished. Accordingly, reductions in the processing overhead associated framebuffer analysis and processing limit or avoid the negative impacts described above.

According to example embodiments of the present invention the computing overhead associated with framebuffer analysis and updating a display is reduced. In this regard, example embodiments of the present invention utilize defined display regions and perform framebuffer analysis and processing with respect to the display regions, and not the entire display frame data, at rates based upon the update criteria for the display regions. In this regard, each display region may have associated update criteria, and the update criteria may be selected such that the criteria is satisfied when a likelihood that the frame data of a display region has changed. In this manner, scans of the frame data associated with the display region at times when no changes to the content have occurred may be limited or avoided, thereby reducing computing overhead. According to various example embodiments, the display regions are sub-portions of the larger display, and the update criteria for the display regions may be selected such that an aggregate rate for scanning the frame buffer is reduced, thereby leading to higher quality of interaction between the remote display 100 and the UE 101.

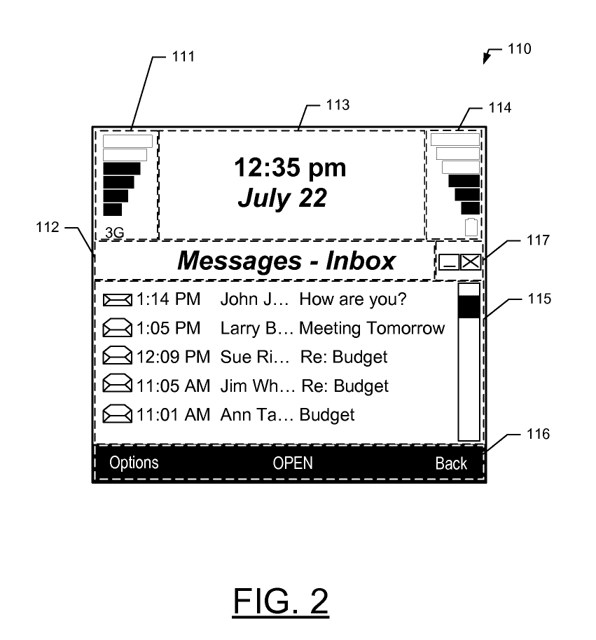

FIG. 2 depicts an example display 100 having defined display regions. The display regions defined with respect to the example display 110 include a signal strength indicator region 111, a title bar region 112, a status information region 113, a battery indicator region 114, a content region 115, a soft key region 116, and a windows controls region 117. Based on the content that is depicted within each of these regions, associated update criteria may be selected.

In this regard, display regions may be defined (e.g., the area of the display associated with the display region may be defined) and the display regions may be classified according to the expected rate of change of the content within the display region and/or the triggering events that lead to changes in the content of the display region. Based on a classification of a display region, associated update criteria may be defined.

In this regard, some display regions may be classified as independently refreshed regions. Independently refreshed regions include display content that changes independently, regardless of user input events, changes to application contexts, or changes to the content of other regions. Examples of independently refreshed regions include the battery indicator region 112, the status information region 113, and, possibly the content region 115 (depending, for example, on the application that is being executed). According to some example embodiments, independently refreshed regions may have update criteria in the form of a timer threshold. In this regard, when a timer passes the threshold, the update criteria may be satisfied. Independently refreshed regions may be further classified as fast update regions and slow update regions. Differences in the timer threshold may be used to implement a fast update region versus a slow update region. Fast update regions display content that may change rapidly. For example, the signal strength indicator region 111 may change rapidly. Slow update regions display content that may change at a relatively slower pace. For example, the status information region 113 may change at a slower pace.

On the other hand, some display regions may be classified as triggered refresh regions. Triggered refresh regions may have content changes in response to events such as a user input, changes in application contexts (e.g., application launch or termination), or changes of content in another display region. Examples of triggered refresh regions include the title bar region 112, the soft key region 116, the windows controls region 117, and possibly the content region 115 (depending on the application that is being executed).

According to various example embodiments, area definitions associated with a display region (e.g., coordinates for the area associated with the display region) and the display region's classification or update criteria may be stored as meta-data in a platform independent format such as Extensible Markup Language (XML). In this regard, according to various example embodiments, each mobile device model, based on, for example, the screen size, resolution, and UI layout, may include a file or other data structure storing the meta-data associated the UI screens. Further, various applications installed on the device (e.g., UE 101) may have stored data for display region area definitions and update criteria. According to some example embodiments, display region data need not be stored for each UI screen, rather one record containing meta-data for display regions of the home screen UI, one record containing meta-data for regions of the menu screen UI, and one record containing meta-data of regions of all other UI screens (e.g., application screens, etc.) may be utilized.

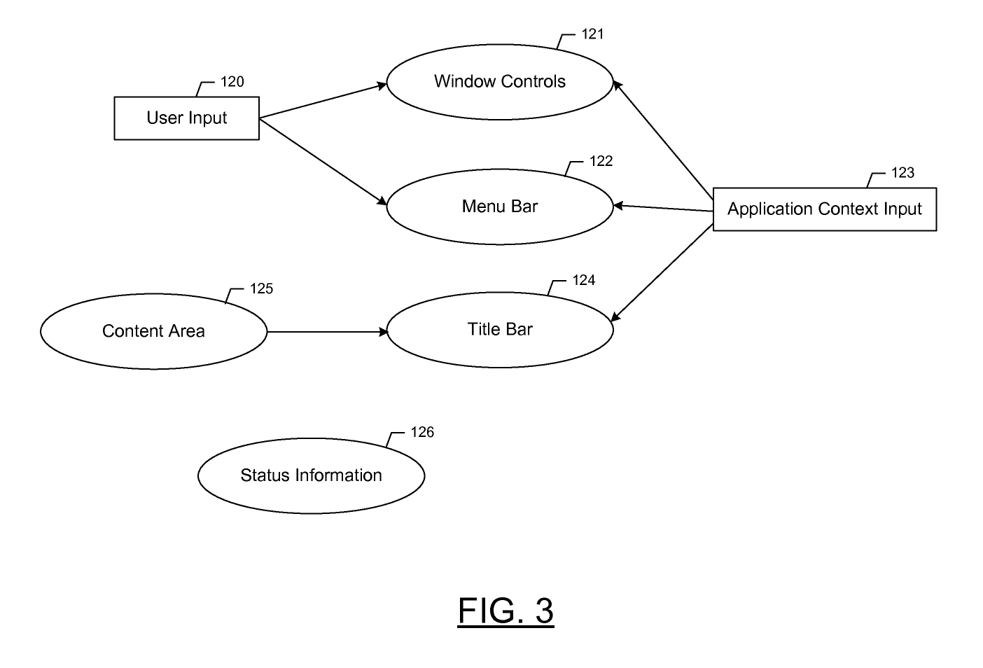

According to some example embodiments, update criteria for display regions may be stored in the form of a dependency graph. The dependency graph may provide information (e.g., criteria) regarding which display regions change in response to user input (e.g., key presses), changes in application contexts, and changes in the frame data/content of other display regions. A dependency graph may be acyclic and consist of nodes. Each node within the dependency graph may represent a different display region. An example of a dependency graph is shown in FIG. 3. The dependency graph of FIG. 3 depicts the dependency graph for a general application screen of a Nokia N810 Internet Tablet.

To model update criteria that is satisfied when a change in another display region occurs, an edge may be directed from a triggering node to the triggered node. In this regard, consider a scenario where a directed edge exists from a node A to a node B. A change in the display region represented by node A may trigger a change in the display region represented by node B. As such, based on the associated dependency graph, the update criteria for the display region of node B may be satisfied when a change in the display region of node A occurs. With respect to FIG. 3, a change in the frame data of the content area region 125 satisfies the update criteria for the title bar region 124.

With respect to display regions having update criteria based on changes in frame data for a triggering display region, the frame data for the triggered display region may be analyzed and compared when a change to the frame data for the triggering display region occurs since the last update for the triggered display region. If changes to the frame data are identified, the changes may be provided to the remote display. If no user input has been detected, then the frame data for the display region need not be analyzed. According to some example embodiments, regardless of whether user input has been received, the display region may be analyzed at a low frequency to avoid loss of synchronization.

To model update criteria that is satisfied when a user input occurs, a user input node may be defined. In this regard, a directed edge between a user input node X and a display region for node Y indicates that the detection of user input may satisfy the update criteria for the display region for node Y. Referring to FIG. 3, update criteria for a window controls region and a menu bar region may be satisfied by the occurrence of user input, as indicated by the edges from the user input node 120 to the window controls region node 121 and the menu bar region node 122.

With respect to display regions having update criteria based on user input, the frame data for the display region may be analyzed and compared when a user input has been detected since the last update for the display region. If changes to the frame data are identified, the changes may be provided to the remote display. If no user input has been detected, then the frame data for the display region need not be analyzed. According to some example embodiments, regardless of whether user input has been received, the display region may be analyzed at a low frequency to avoid loss of synchronization.

To model update criteria that is satisfied when a application context changes, an application context input node may be defined. In this regard, a directed edge between an application context input node X and a display region for node Y indicates that the detection of a change in application context may satisfy the update criteria for the display region for node Y. Also, referring to FIG. 3, update criteria for a window controls region, a menu bar region, and a title bar region may be satisfied by the occurrence of a change in an application context, as indicated by the edges from the application context input node 123 to the window controls region node 121, the menu bar region node 122, and the title bar node 124.

With respect to display regions having update criteria based on application context changes (e.g., application launch and/or application termination), the frame data for the display region may be analyzed and compared when an application context change occurs since the last update for the display region. A change in the application context may be determined by interrogating or querying the underlying operation system (e.g., window manager component). If changes to the frame data are identified, the changes may be provided to the remote display. If no application context change is identified, then the frame data for the display region need not be analyzed. According to some example embodiments, regardless of whether user input has been received, the display region may be analyzed at a low frequency to avoid loss of synchronization.

To model update criteria for independently refreshed display regions, a disconnected node with no incoming edges may be provided. In this regard, independently refreshed display region nodes may have outgoing edges if changes to the frame data for the display region satisfy update criteria for other display regions. Referring to FIG. 3, the content area node 125 and the status information node 126 are defined as being independently refreshed.

As independently refreshed display regions, the current frame data for the associated display region may be compared to subsequent frame data for the display region in response to the passing of a timer threshold. In this regard, an appropriate timer threshold may be set for fast update regions and slow update regions. When the timer threshold is passed, the frame data may be compared and the changed portions may be provided to a remote display.

Alternatively, more sophisticated update criteria may be utilized for independently refreshed display regions. In this regard, according to some example embodiments, the frame data may be compared after a given number of frame changes, where the given number of frame changes may be defined based on processing load and/or a probabilistic rate of change in a display region's frame data. Further, for a status information region that shows a clock, such as the status information region 113, analyzing the frame data every 1800 iterations may be sufficient without any perceptible loss in user experience, assuming the iterations occur a rate of thirty per second (based on thirty frames per second). Further, according to various example embodiments, the update criteria (e.g., timer threshold) may also be determined autonomously, based on observations and learning a display region's temporal behavior, either in the beginning or at regular intervals, to determine the actual frequency of frame data change.

Further, as indicated with respect to nodes 121, 122, and 124 of FIG. 3, two or more sets of update criteria may be used to trigger an analysis of frame data for the associated display region. To avoid duplicate traversal of display regions during a single iteration, after each display region has been traversed, the corresponding node in the dependency graph may be marked indicating that the display region has already been analyzed. During a single iteration, a display region node that is marked need not be re-analyzed. The mark may then be cleared after the iteration.

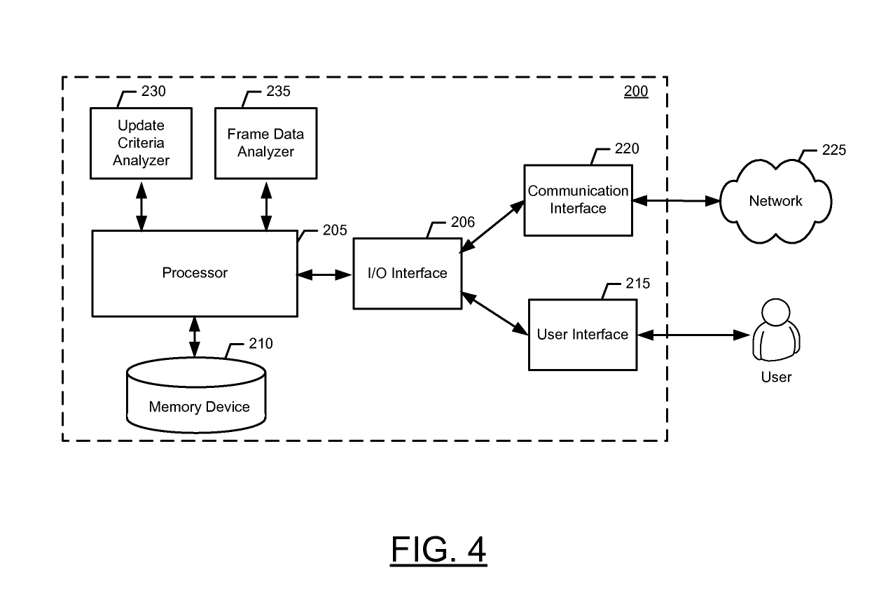

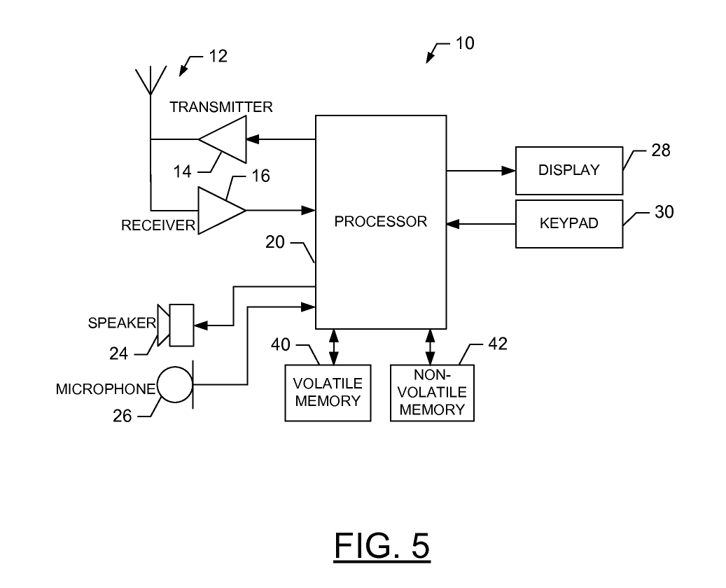

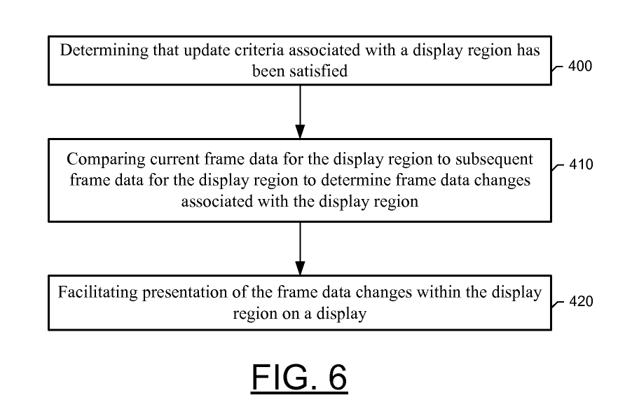

The description provided above and generally herein illustrates example methods, example apparatuses, and example computer program products for display framebuffer processing. FIGS. 4 and 5 illustrate example apparatus embodiments of the present invention configured to perform the various functionalities described herein. FIG. 4 depicts an example apparatus that is configured to perform various functionalities from the perspective of a UE (e.g., UE 101) as described with respect to FIG. 1 and as generally described herein. FIG. 5 depicts an example UE apparatus in the form of a mobile terminal configured to perform various functionalities from the perspective of a UE 101 depicted in FIG. 1 and as generally described herein. The example apparatuses depicted in FIGS. 4 and 5 may also be configured to perform example methods of the present invention, such as those described with respect to FIG. 6.

Referring now to FIG. 4, in some example embodiments, the apparatus 200 may, be embodied as, or included as a component of, a communications device with wired or wireless communications capabilities. In this regard, the apparatus 200 may be configured to operate in accordance with the functionality of a UE as described herein. In some example embodiments, the apparatus 200 may be part of a communications device (e.g., access point 100 or UE 101), such as a stationary or a mobile terminal. As a stationary terminal, the apparatus 200 may be part of an access point (e.g., a base station, wireless router, or the like), a computer, a server, a device that supports network communications, or the like. As a mobile terminal, the apparatus 200 may be a mobile computer, mobile telephone, a portable digital assistant (PDA), a pager, a mobile television, a gaming device, a mobile computer, a laptop computer, a camera, a video recorder, an audio/video player, a radio, and/or a global positioning system (GPS) device, any combination of the aforementioned, or the like. Regardless of the type of communications device, apparatus 200 may also include computing capabilities.

The example apparatus 200 includes or is otherwise in communication with a processor 205, a memory device 210, an Input/Output (I/O) interface 206, a communications interface 215, user interface 220, a scheduling manager 230, and a schedule analyzer 235. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a mobile terminal) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 220 and the user interface 215. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention.

The communication interface 215 may be any device or means embodied in either hardware, a computer program product, or a combination of hardware and a computer program product that is configured to receive and/or transmit data from/to a network 225 and/or any other device or module in communication with the example apparatus 200. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11 g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications at the network layer, possibly via Internet Protocol (IP).

The user interface 220 may be in communication with the processor 205 to receive user input via the user interface 220 and/or to present output to a user as, for example, audible, visual, mechanical or other output indications. The user interface 220 may include, for example, a keyboard, a mouse, a joystick, a display (e.g., a touch screen display), a microphone, a speaker, or other input/output mechanisms. Further, the processor 205 may comprise, or be in communication with, user interface circuitry configured to control at least some functions of one or more elements of the user interface. The processor 205 and/or user interface circuitry may be configured to control one or more functions of one or more elements of the user interface through computer program instructions (e.g., software and/or firmware) stored on a memory accessible to the processor 205 (e.g., volatile memory, non-volatile memory, and/or the like). In some example embodiments, the user interface circuitry is configured to facilitate user control of at least some functions of the apparatus 200 through the use of a display and configured to respond to user inputs. The processor 205 may also comprise, or be in communication with, display circuitry configured to display at least a portion of a user interface, the display and the display circuitry configured to facilitate user control of at least some functions of the apparatus 200.

The update criteria analyzer 230 and/or the frame data analyzer 235 of example apparatus 200 may be any means or device embodied, partially or wholly, in hardware, a computer program product, or a combination of hardware and a computer program product, such as processor 205 implementing stored instructions to configure the example apparatus 200, or a hardware configured processor 205, that is configured to carry out the functions of the update criteria analyzer 230 and/or the frame data analyzer 235 as described herein. In an example embodiment, the processor 205 includes, or controls, the update criteria analyzer 230 and/or the frame data analyzer 235. The update criteria analyzer 230 and/or the frame data analyzer 235 may be, partially or wholly, embodied as processors similar to, but separate from processor 205. In this regard, the update criteria analyzer 230 and/or the frame data analyzer 235 may be in communication with the processor 205. In various example embodiments, the update criteria analyzer 230 and/or the frame data analyzer 235 may, partially or wholly, reside on differing apparatuses such that some or all of the functionality of the update criteria analyzer 230 and/or the frame data analyzer 235 may be performed by a first apparatus, and the remainder of the functionality of the update criteria analyzer 230 and/or the frame data analyzer 235 may be performed by one or more other apparatuses.

The apparatus 200 and the processor 205 may be configured to perform the following functionality via the update criteria analyzer 230. In this regard, the update criteria analyzer 230 may be configured to determine that update criteria associated with a display region has been satisfied. In this regard, the display region is less than an entire area of a display. According to some example embodiments, the update criteria and a description of an area of the display region may be stored as meta-data, possibly for an associated application. In this regard, the meta-data may be stored in the memory device 210.

The update criteria may take a number of forms and may be satisfied in a manner associated with the form. For example, according to some example embodiments, the update criteria for a display region may be satisfied when a timer threshold has been passed. Additionally, or alternatively, according to some example embodiments, the update criteria for a display region may be satisfied when user input has been received via a user interface. Additionally, or alternatively, according to some example embodiments, the update criteria for a display region may be satisfied when a context of an application associated with the current frame data has changed. Additionally, or alternatively, according to some example embodiments, the update criteria for a display region may be satisfied when frame data changes associated with another display region have occurred.

The apparatus 200 and the processor 205 may be configured to perform the following functionality via the frame data analyzer 235. In this regard, the schedule analyzer 235 may be configured to compare current frame data for the display region to subsequent frame data for the display region to determine frame data changes associated with the display region. The current frame data and/or the subsequent frame data may be stored in a framebuffer included within memory device 210. According to some example embodiments, the comparing performed by the frame data analyzer 235 may be performed in response to the update criteria being satisfied. Further, according to some example embodiments, the frame data analyzer 235 may be configured to facilitate presentation of the frame data changes within a display region on a display. In this regard, the display may be a display of the user interface 215, or the display may be a remote display (e.g., remote display 100).

Referring now to FIG. 5, a more specific example apparatus in accordance with various embodiments of the present invention is provided. The example apparatus of FIG. 5 is a mobile terminal 10 configured to communicate within a wireless network, such as a cellular communications network. The mobile terminal 10 may be configured to perform the functionality of UE 101 and/or apparatus 200 as described herein. More specifically, the mobile terminal 10 may be caused to perform the functionality of the update criteria analyzer 230 and/or the frame data analyzer 235 via the processor 20. In this regard, processor 20 may be an integrated circuit or chip configured similar to the processor 205 together with, for example, the I/O interface 206. Further, volatile memory 40 and non-volatile memory 42 may configured to support the operation of the processor 20 as computer readable storage media.

The mobile terminal 10 may further include an antenna 12, a transmitter 14, and a receiver 16, which may be included as parts of a communications interface of the mobile terminal 10. The speaker 24, the microphone 26, the display 28, and the keypad 30 may be included as parts of a user interface.

FIG. 6 illustrates flowcharts of example systems, methods, and/or computer program products according to example embodiments of the invention. It will be understood that each block or operation of the flowcharts, and/or combinations of blocks or operations in the flowcharts, can be implemented by various means. Means for implementing the blocks or operations of the flowcharts, combinations of the blocks or operations in the flowchart, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions may be stored on a memory device, such as memory device 210, of an example apparatus, such as example apparatus 200, and executed by a processor, such as the processor 205. As will be appreciated, any such program code instructions may be loaded onto a computer or other programmable apparatus (e.g., processor 205, memory device 210, or the like) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

FIG. 6 depicts one or more flowcharts of example methods for display framebuffer processing. An example method includes determining that update criteria associated with a display region has been satisfied at 400. In this regard, the display region is less than an entire area of the display. The update criteria may take a number of forms and may be satisfied in a manner associated with the form. For example, according to some example embodiments, the update criteria for a display region may be satisfied when a timer threshold has been passed. Additionally, or alternatively, according to some example embodiments, the update criteria for a display region may be satisfied when user input has been received via a user interface. Additionally, or alternatively, according to some example embodiments, the update criteria for a display region may be satisfied when a context of an application associated with the current frame data has changed. Additionally, or alternatively, according to some example embodiments, the update criteria for a display region may be satisfied when frame data changes associated with another display region have occurred. According to some example embodiments, the update criteria and a description of an area of the display region may be stored as meta-data for an associated application.

An example method may also include comparing current frame data for the display region to subsequent frame data for the display region to determine frame data changes associated with the display region at 410. In this regard, the comparing may be performed in response to the update criteria being satisfied. Further, according to some example embodiments, an example method may include facilitating presentation of the frame data changes within the display region on a display at 420.

Additional example embodiments of the present invention are described as follows. An example method comprises determining, via a processor, that update criteria associated with a display region has been satisfied, comparing current frame data for the display region to subsequent frame data for the display region to determine frame data changes associated with the display region, wherein comparing is performed in response to the update criteria being satisfied, and facilitating presentation of the frame data changes within the display region on a display, the display region being less than an entire area of the display. According to some example embodiments, determining that the update criteria has been satisfied includes determining that a timer threshold has been passed. According to some example embodiments, determining that the update criteria has been satisfied includes determining that user input has been received via a user interface. According to some example embodiments, determining that the update criteria has been satisfied includes determining that a context of an application associated with the current frame data has changed. According to some example embodiments, determining that the update criteria has been satisfied includes determining that frame data changes associated with another display region have occurred. According to some example embodiments, determining that the update criteria associated with the display region has been satisfied includes referencing the update criteria and an area of the display region stored as meta-data for an associated application.

Another example embodiment of the present invention is an apparatus comprising at least one processor and at least one memory including computer program code, the at least one memory and the computer program code configured to, with the at least one processor, cause the apparatus at least to perform determining that update criteria associated with a display region has been satisfied, comparing current frame data for the display region to subsequent frame data for the display region to determine frame data changes associated with the display region, wherein comparing is performed in response to the update criteria being satisfied, and facilitating presentation of the frame data changes within the display region on a display, the display region being less than an entire area of the display. According to some example embodiments, the apparatus caused to perform determining that the update criteria has been satisfied includes being caused to perform determining that a timer threshold has been passed. According to some example embodiments, the apparatus caused to perform determining that the update criteria has been satisfied includes being caused to perform determining that user input has been received via a user interface. According to some example embodiments, the apparatus caused to perform determining that the update criteria has been satisfied includes being caused to perform determining that a context of an application associated with the current frame data has changed. According to some example embodiments, the apparatus caused to perform determining that the update criteria has been satisfied includes being caused to perform determining that frame data changes associated with another display region have occurred. According to some example embodiments, the apparatus caused to perform determining that the update criteria associated with the display region has been satisfied includes being caused to perform referencing the update criteria and an area of the display region stored as meta-data for an associated application. According to some example embodiments, the apparatus comprises a mobile terminal, and the apparatus further comprises user interface circuitry and user interface software configured to facilitate user control of at least some functions of the mobile terminal through the use of a display and configured to respond to user inputs, and a display and display circuitry configured to display at least a portion of a user interface of the mobile terminal, the display and the display circuitry configured to facilitate user control of at least some functions of the mobile terminal. According to some example embodiments, the apparatus further comprises a communications interface configured to transmit the frame data changes to the display, the display being a remote device display.

Another example embodiment of the present invention is a computer program product comprising at least one computer-readable storage medium having executable computer-readable program code instructions stored therein, the computer-readable program code instructions for causing an apparatus to perform determining that update criteria associated with a display region has been satisfied, comparing current frame data for the display region to subsequent frame data for the display region to determine frame data changes associated with the display region, wherein comparing is performed in response to the update criteria being satisfied, and facilitating presentation of the frame data changes within the display region on a display, the display region being less than an entire area of the display. According to some example embodiments, the computer-readable program code instructions for causing the apparatus to perform determining that the update criteria has been satisfied include computer-readable program code instructions for causing the apparatus to perform determining that a timer threshold has been passed. According to some example embodiments, the computer-readable program code instructions for causing the apparatus to perform determining that the update criteria has been satisfied include computer-readable program code instructions for causing the apparatus to perform determining that user input has been received via a user interface. According to some example embodiments, the computer-readable program code instructions for causing the apparatus to perform determining that the update criteria has been satisfied include computer-readable program code instructions for causing the apparatus to perform determining that a context of an application associated with the current frame data has changed. According to some example embodiments, the computer-readable program code instructions for causing the apparatus to perform determining that the update criteria has been satisfied include computer-readable program code instructions for causing the apparatus to perform determining that frame data changes associated with another display region have occurred. According to some example embodiments, the computer-readable program code instructions for causing the apparatus to perform determining that the update criteria associated with the display region has been satisfied include computer-readable program code instructions for causing the apparatus to perform referencing the update criteria and an area of the display region stored as meta-data for an associated application.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method comprising:
determining, via a processor, that update criteria associated with a display region has been satisfied;
comparing current frame data for the display region to subsequent frame data for the display region to determine frame data changes associated with the display region, wherein comparing is performed in response to the update criteria being satisfied; and
facilitating presentation of the frame data changes within the display region on a display, the display region being less than an entire area of the display.

2. The method of claim 1, wherein determining that the update criteria has been satisfied includes determining that a timer threshold has been passed.

3. The method of claim 1, wherein determining that the update criteria has been satisfied includes determining that user input has been received via a user interface.

4. The method of claim 1, wherein determining that the update criteria has been satisfied includes determining that a context of an application associated with the current frame data has changed.

5. The method of claim 1, wherein determining that the update criteria has been satisfied includes determining that frame data changes associated with another display region have occurred.

6. The method of claim 1, wherein determining that the update criteria associated with the display region has been satisfied includes referencing the update criteria and an area of the display region stored as meta-data for an associated application.

7. An apparatus comprising at least one processor and at least one memory including computer program code, the at least one memory and the computer program code configured to, with the at least one processor, cause the apparatus at least to:
determine that update criteria associated with a display region has been satisfied;
compare current frame data for the display region to subsequent frame data for the display region to determine frame data changes associated with the display region, wherein the current frame data is compared in response to the update criteria being satisfied; and
facilitate presentation of the frame data changes within the display region on a display, the display region being less than an entire area of the display.

8. The apparatus of claim 7, wherein the apparatus caused to determine that the update criteria has been satisfied includes being caused to determine that a timer threshold has been passed.

9. The apparatus of claim 7, wherein the apparatus caused to determine that the update criteria has been satisfied includes being caused to perform determine that user input has been received via a user interface.

10. The apparatus of claim 7, wherein the apparatus caused to determine that the update criteria has been satisfied includes being caused to determine that a context of an application associated with the current frame data has changed.

11. The apparatus of claim 7, wherein the apparatus caused to determine that the update criteria has been satisfied includes being caused to determine that frame data changes associated with another display region have occurred.

12. The apparatus of claim 7, wherein the apparatus caused to determine that the update criteria associated with the display region has been satisfied includes being caused to reference the update criteria and an area of the display region stored as meta-data for an associated application.

13. The apparatus of claim 7, wherein the apparatus comprises a mobile terminal; and wherein the apparatus further comprises user interface circuitry and user interface software configured to facilitate user control of at least some functions of the mobile terminal through the use of a display and configured to respond to user inputs, and a display and display circuitry configured to display at least a portion of a user interface of the mobile terminal, the display and the display circuitry configured to facilitate user control of at least some functions of the mobile terminal.

14. The apparatus of claim 18 further comprising a communications interface configured to transmit the frame data changes to the display, the display being a remote device display.

15. A computer program product comprising at least one computer-readable storage medium having executable computer-readable program code instructions stored therein, the computer-readable program code instructions for causing an apparatus to:
determine that update criteria associated with a display region has been satisfied;
compare current frame data for the display region to subsequent frame data for the display region to determine frame data changes associated with the display region, wherein the current frame data is compared in response to the update criteria being satisfied; and
facilitate presentation of the frame data changes within the display region on a display, the display region being less than an entire area of the display.

16. The computer program product of claim 15, wherein the computer-readable program code instructions for causing the apparatus to determine that the update criteria has been satisfied include computer-readable program code instructions for causing the apparatus to determine that a timer threshold has been passed.

17. The computer program product of claim 15, wherein the computer-readable program code instructions for causing the apparatus to determine that the update criteria has been satisfied include computer-readable program code instructions for causing the apparatus to determine that user input has been received via a user interface.

18. The computer program product of claim 15, wherein the computer-readable program code instructions for causing the apparatus to determine that the update criteria has been satisfied include computer-readable program code instructions for causing the apparatus to perform determine that a context of an application associated with the current frame data has changed.

19. The computer program product of claim 15, wherein the computer-readable program code instructions for causing the apparatus to determine that the update criteria has been satisfied include computer-readable program code instructions for causing the apparatus to determine that frame data changes associated with another display region have occurred.

20. The computer program product of claim 15, wherein the computer-readable program code instructions for causing the apparatus to determine that the update criteria associated with the display region has been satisfied include computer-readable program code instructions for causing the apparatus to reference the update criteria and an area of the display region stored as meta-data for an associated application.
